(19) United States
(12) Patent Application Publication
(10) Pub. No.: US 2024/0182364 A1
(43) Pub. Date: Jun. 6, 2024

(54) UTILIZATION OF SPENT CHROMIA/ALUMINA CATALYST FOR CEMENT PRODUCTION

(71) Applicant: SABIC Global Technologies B.V., Bergen op Zoom (NL)

(72) Inventors: Khaja Aliuddin SHARIEF, Riyadh (SA); Mohammed Bismillah ANSARI, Riyadh (SA); Venkata Malleswara Rao TADIBOYINA, Geleen (NL)

(21) Appl. No.: 18/553,856

(22) PCT Filed: Apr. 13, 2022
(86) PCT No.: PCT/IB2022/053497

§ 371 Date: Oct. 4, 2023

Related U.S. Application Data
(60) Provisional application No. 63/175,765, filed on Apr. 16, 2021.

(51) Int. Cl. C04B 28/14; C04B 7/32; C04B 7/44; C04B 7/52; C04B 22/14; C04B 111/10

(52) U.S. Cl. CPC C04B 28/14; C04B 7/32; C04B 7/44; C04B 7/52; C04B 22/149; C04B 2111/1081

(57) ABSTRACT

Methods of producing cement using a spent hydrocarbon dehydrogenation catalyst are disclosed. A spent hydrocarbon dehydrogenation catalyst comprising alumina is processed to produce a processed raw material. The processed raw material is then used as a component for producing the cement. Compositions of cement including the processed raw material are disclosed.

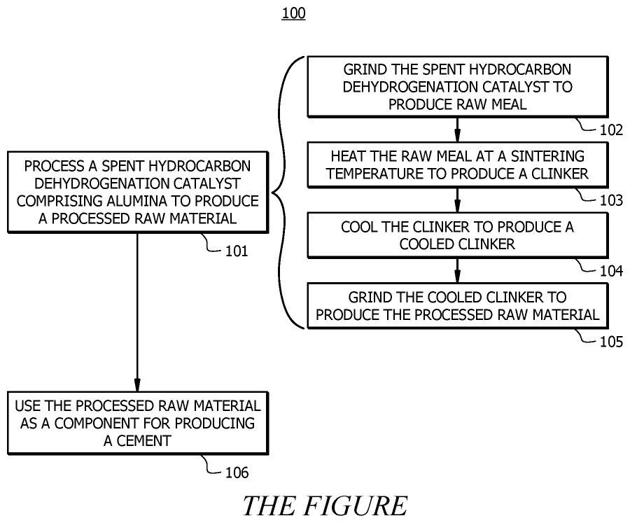

### CROSS REFERENCE TO RELATED APPLICATIONS

This application claims the benefit of priority of U.S. Provisional Patent Application No. 63/175,765, filed Apr. 16, 2021, which is hereby incorporated by reference in its entirety.

### FIELD OF INVENTION

The present invention generally relates to processes for reusing spent catalysts to produce cement. More specifically, the present invention relates to processes for producing cement that include using spent hydrocarbon dehydrogenation catalyst as a component of the cement.

### BACKGROUND OF THE INVENTION

Catalysts are vital materials in the chemical industry. In chemical production processes, catalysts become spent (i.e., loss of sufficient catalytic activity for catalyzing the relevant chemical reactions). Loss of sufficient catalytic activity usually occurs after many on stream-regeneration cycles. A large amount of spent catalysts is generated daily around the world. Generally, these spent catalysts are disposed by landfilling. However, there are several drawbacks associated with disposing a catalyst in a landfill.

First, as many of the catalysts contain toxic components, landfilling a large amount these toxic materials can have a significant negative impact on the environment. Second, landfills of the hazardous materials require long term maintenance and surveillance to prevent accidental leakage and environmental disasters, thereby increasing the costs of disposing the spent catalysts. Third, landfilling the spent catalysts is not a cost effective use of the land.

Overall, while methods for disposing spent catalysts from chemical production processes exist, the need for improvements in this field persists in light of at least the aforementioned drawback for the conventional systems and methods.

### BRIEF SUMMARY OF THE INVENTION

A solution to at least the above mentioned problems associated with the methods for disposing spent catalyst is discovered. The solution resides in a method for producing cement using a spent hydrocarbon dehydrogenation catalyst as a raw material. This can be beneficial for mitigating or eliminating the need for disposing spent catalysts via landfill, thereby reducing the continuous usage of land and increasing value for spent catalyst. Additionally, the disclosed method can use a reducing agent to reduce toxic metal ions such as Cr⁶⁺ such that the produced cement meets health and environmental requirements and/or standards, thereby mitigating the hazardous impact of the spent catalysts and avoiding the need for long term maintenance and surveillance for the spent catalyst-containing landfills. Therefore, the methods and cement compositions of the present invention provide a technical solution to at least some of the problems associated with the conventional methods for disposing spent catalysts.

Embodiments of the invention include a method of producing cement. The method comprises processing a spent hydrocarbon dehydrogenation catalyst comprising alumina to produce a processed raw material. The method comprises using the processed raw material as a component for producing a cement material.

Embodiments of the invention include a method of producing cement. The method comprises processing a spent hydrocarbon dehydrogenation catalyst comprising chromium supported on alumina to produce a processed raw material. The Cr⁶⁺ in the spent hydrocarbon dehydrogenation catalyst typically is in the range of 0.01 to 0.2 wt. % of the catalyst, depending on the nature of unloading procedures of a spent catalyst. The method comprises producing cement using the processed raw material as a source of alumina.

In embodiments of the invention, the total chromium in the final cement is in the range of 20 to 1000 parts per million in weight (ppmw) or 0.002 to 0.1 wt. %. Depending on the addition rate of a spent hydrocarbon dehydrogenation catalyst to the other raw material mix of the cement production process, the Cr⁶⁺ in pre-finished cement can be maintained at a concentration of 0.4 to 4 ppmw and all ranges and values there between including ranges of 0.4 to 0.8 ppmw, 0.8 to 1.2 ppmw, 1.2 to 1.6 ppmw, 1.6 to 2.0 ppmw, 2.0 to 2.4 ppmw, 2.4 to 2.8 ppmw, 2.8 to 3.2 ppmw, 3.2 to 3.6 ppmw, and 3.6 to 4.0 ppmw. The majority of Portland cement samples can contain Cr(VI) in the range of 2 to 25 ppmw, depending on the geographic location and source and type of raw materials used for cement production. Therefore, a Cr(VI) level in the range of 0.4 to 4 ppmw resulting from spent chromium catalyst addition can be well below the typical Cr(VI) specifications in the final cement. In embodiments of the invention, if Cr(VI) is present from other raw materials used for cement production, conventional reducing agents (e.g., iron sulfate, manganese sulfate, stannous sulfate, etc.) corresponding to the Cr⁶⁺ amount therein (based on the spent catalyst addition rate) can be added to the pre-finished cement during the finishing step (i.e., blending of chemicals and grinding to meet final cement specifications) of the cement to meet the typical Cr(VI) industrial specifications in the final cement (2 to 25 ppmw, depending on the geographical locations). The Cr(VI) contribution from the spent catalyst addition can be kept at 0.4 to 4 ppmw by controlling the spent chromium catalyst addition rate.

Embodiments of the invention include a method of producing cement. The method comprises grinding a spent hydrocarbon dehydrogenation catalyst comprising chromium supported on alumina to produce a raw meal. The method further comprises heating the raw meal at a sintering temperature to produce a clinker. The method comprises cooling the clinker to produce a cooled clinker. The method comprises grinding the cooled clinker to produce a processed raw material. The method comprises mixing the processed raw material with gypsum and a reducing agent to produce cement. The Cr(VI) contribution from the spent catalyst addition can be kept at 0.4 to 4 ppmw, depending on the spent chromium catalyst addition rate.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The term “spent catalyst,” as that term is used in the specification and/or claims, means the catalyst that was subjected to alkane (e.g., ethane, propane, isobutane, butanes) dehydrogenation reaction and catalyst regeneration conditions in fixed bed reactor and/or fluidized bed reactor technology for several hundreds to thousands of reaction cycles. The reaction cycle includes different steps such as alkane dehydrogenation, catalyst regeneration/reheating, purging, etc. The catalysts used in fixed bed reactor technology can have a lifetime of approximately 2 years, while the catalysts in fluidized bed reactor can have an age distribution (ranging from minutes to years, as there is always daily catalyst make-up with fresh catalyst to maintain the fluid bed reactor inventory and production level).

The term “raw meal,” as that term is used in the specification and/or claims means the raw materials, including the material sources based on compounds such as lime, silica, alumina, and iron oxide.

The term “clinker,” as that term is used in the specification and/or claims means a solid material produced by heating a homogeneous mixture of raw materials in a rotary kiln at a high temperature of about 1450° C. This clinker is typically an intermediate product of the cement production process.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following FIGURES, detailed description, and examples. It should be understood, however, that the FIGURES, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawing, in which:

The FIGURE shows a schematic flowchart for a method of producing cement, according to embodiments of the invention.

### DETAILED DESCRIPTION OF THE INVENTION

Currently, spent catalysts, including spent hydrocarbon dehydrogenation catalysts, are generally disposed of in landfills. However, often, the spent catalysts can include toxic components, such as heavy metals. Hence, disposing spent catalysts via landfill carries a risk for land and/or soil pollution and causes human health concerns. Consequently, long term maintenance and surveillance for landfill sites of spent catalysts have to be implemented, resulting in high costs for disposing spent catalysts. Additionally, the land usage of landfilling with a large amount of spent catalysts can further increase the cost of disposing spent catalysts and result in waste of limited land resources. The present invention provides a solution to these problems. The solution is premised on a method of producing cement that includes processing an alumina containing spent dehydrogenation catalyst and using the processed spent dehydrogenation catalyst as a component for a cement, thereby increasing the value of the spent catalysts by reusing them, and mitigating or avoiding disposing the spent catalysts via landfill. Thus, the disclosed method is capable of reducing land usage and eliminating the need of long term maintenance and surveillance for the landfill sites. In embodiments of the invention, the methods provides a cement with corrosion inhibitors including chromium compounds. The provided cement can meet the needs of the construction industry. The spent catalyst, in embodiments of the invention, comprises Cr₂O₃/Al₂O₃(Dehydro-Catofin catalyst), where chromium is in Cr³⁺ form, which is considered to be less harmful than the commercially used chromium salts of Cr⁶⁺. Cements blended with a Cr³⁺ source can be useful for making concrete mixes for use in structures where metal reinforcement is needed. In embodiments of the invention, Cr³⁺ in the cement can be oxidized to form Cr⁶⁺. Additionally, according to embodiments of the invention, the disclosed method can include adding a reducing agent to reduce concentrations of toxic metal ions to meet health and environmental requirements for cements, thereby mitigating the negative impact of spent catalysts on human health and the environment. These and other non-limiting aspects of the present invention are discussed in further detail in the following sections.

In embodiments of the invention, the method of producing cement comprises using a spent catalyst as a component for producing cement. Notably, the spent catalyst can include a hydrocarbon dehydrogenation catalyst comprising alumina. Thus, the spent catalyst can be used to replace at least some bauxite in a process of producing cement. With reference to the FIGURE, a schematic diagram is shown for method 100, which is used for producing cement.

According to embodiments of the invention, as shown in block 101, method 100 includes processing a spent hydrocarbon dehydrogenation catalyst comprising alumina to produce a processed raw material. In embodiments of the invention, the spent hydrocarbon dehydrogenation catalyst comprises mainly oxides of chromium and aluminum, and some small amounts (<2 wt. %) of potassium, silica, titania, zirconia, iron oxides, or combinations thereof. The spent catalyst can further contain a small amount of carbon or coke deposits (100 ppm to 0.1 wt. %) generated within the process. The variation in the coke deposits may depend on the type of reactor technology (fluidized bed/fixed bed reactor) and the nature of catalyst unloading procedures. The spent hydrocarbon dehydrogenation catalyst can comprise alumina as a support material. In embodiments of the invention, the alumina is in the form of different phases of aluminum oxide (gamma-alumina, theta-alumina, and delta-alumina), chromia-alumina mixed oxide, or combinations thereof. The chromium of the spent hydrocarbon dehydrogenation catalyst can be in form of Cr₂O₃, CrO₃, K₂CrO₄, Cr₂O₃Al₂O₃, or combinations thereof.

According to embodiments of the invention, the spent hydrocarbon dehydrogenation catalyst includes 10 to 16 wt. % chromium and all ranges and values there between including ranges of 10 to 11 wt. %, 11 to 12 wt. %, 12 to 13 wt. %, 13 to 14 wt. %, 14 to 15 wt. %, and 15 to 16 wt. %. The spent hydrocarbon dehydrogenation catalyst can include 75 to 82 wt. % alumina and all ranges and values there between including ranges of 75 to 76 wt. %, 76 to 77 wt. %, 77 to 78 wt. %, 78 to 79 wt. %, 79 to 80 wt. %, 80 to 81 wt. %, and 81 to 82 wt. %. In embodiments of the invention, the spent hydrocarbon dehydrogenation catalyst has a particle size (i.e., average particle size or average diameter) of 1 μm to 10 mm, preferably 1 mm to 10 mm, more preferably 2 mm to 5 mm. In embodiments of the invention, it is preferred that 80% to 99% by weight of the spent hydrocarbon dehydrogenation catalyst has an average particle size or average diameter of from 1 mm to 10 mm. In embodiments, preferably 80% or more by weight of the spent hydrocarbon dehydrogenation catalyst has a particle size (i.e., average particle size or average diameter) of 2 mm to 4 mm, e.g. 80 to 99% by weight. In embodiments, the spent hydrocarbon dehydrogenation catalyst has a particle size (i.e., average particle size or average diameter) of 2 μm to 3 mm and a surface area in a range of 30 to 70 m²/g. The hydrocarbons can include ethane, propane, isobutane, butanes, or combinations thereof.

According to embodiments of the invention, as shown in block 102, processing at block 101 includes grinding the spent hydrocarbon dehydrogenation catalyst comprising chromium supported on alumina to produce a raw meal. The raw meal may have a particle sizes of 1 micron to 200 μm. The grinding at block 102 can be conducted in conventional size reduction equipment.

According to embodiments of the invention, as shown in block 103, processing at block 101 includes heating the raw meal at a sintering temperature to produce a clinker. At block 103, the sintering temperature is in a range of 1400 to 1500° C. and all ranges and values there between including ranges of 1400 to 1410° C., 1410 to 1420° C., 1420 to 1430° C., 1430 to 1440° C., 1440 to 1450° C., 1450 to 1460° C., 1460 to 1470° C., 1470 to 1480° C., 1480 to 1490° C., and 1490 to 1500° C. The heating can be conducted in a rotary kiln. In embodiments of the invention, the cylindrical kiln comprises steel. The kiln can be lined with refractory lining. The refractory lining is typically based on dense alumina-phase in combination with other secondary oxides. In embodiments of the invention, the clinker can include round nodules having an average size of 1 to 25 mm and all ranges and values there between.

According to embodiments of the invention, as shown in block 104, processing at block 101 includes cooling the clinker to produce a cooled clinker. The clinker at block 104 is cooled from the sintering temperature to about 90° C., e.g., 89.9 to 90.1° C., and all ranges and values there between. According to embodiments of the invention, as shown in block 105, processing at block 101 includes grinding the cooled clinker to produce the processed raw material.

According to embodiments of the invention, as shown in block 106, method 100 includes using the processed raw material as a component for producing a cement. In embodiments of the invention, the cement is produced by mixing the processed raw material with gypsum and a reducing agent. In embodiments of the invention, the spent catalyst is less than 0.5 wt. % of the total raw material for making cement. The cement can comprise the spent hydrocarbon dehydrogenation catalyst in the range of 0.02 to 0.2 wt. % of the total raw materials used for cement production. This can be equivalent to saving of bauxite material up to 20% relative to its bauxite material original requirement.

In the context of the present invention, at least the following 15 embodiments are described. Embodiment 1 is a method of producing cement. The method includes processing a spent hydrocarbon dehydrogenation catalyst containing alumina to produce a processed raw material. The method further includes using the processed raw material as a component for producing the cement. Embodiment 2 is the method of embodiment 1, wherein the spent hydrocarbon dehydrogenation catalyst contains chromium supported on alumina. Embodiment 3 is the method of either of embodiments 1 or 2, wherein the chromium of the spent hydrocarbon dehydrogenation catalyst is in a form of Cr₂O₃, CrO₃, K₂CrO₄, Cr₂O₃Al₂O₃, or combinations thereof. Embodiment 4 is the method of any of embodiments 1 to 3, wherein the cement contains less than 0.02 ppmw Cr⁶⁺ from the spent catalyst. Embodiment 5 is the method of any of embodiments 1 to 4, wherein the spent hydrocarbon dehydrogenation catalyst has a particle size in a range of 2 microns to 3 mm. Embodiment 6 is the method of any of embodiments 1 to 5, wherein the catalyst contains 10 to 16 wt. % chromium and 75 to 85 wt. % alumina. Embodiment 7 is the method of any of embodiments 1 to 6, wherein the alumina is in a form of gamma-alumina, theta-alumina, and delta-alumina, chromia-alumina mixed oxide, or combinations thereof. Embodiment 8 is the method of any of embodiments 1 to 7, wherein the processed raw material is used as an alumina source for the cement. Embodiment 9 is the method of any of embodiments 1 to 8, wherein the processing step includes grinding a spent hydrocarbon dehydrogenation catalyst containing chromium supported on alumina to produce a raw meal. The method further includes heating the raw meal at a sintering temperature to produce a clinker. The method still further includes cooling the clinker to produce a cooled clinker, and grinding the cooled clinker to produce the processed raw material. Embodiment 10 is the method of any of embodiments 1 to 9, wherein the cement is produced via a step including mixing the processed raw material with gypsum and a reducing agent to produce a cement. Embodiment 11 is the method of any of embodiments 1 to 10, wherein the reducing agent contains ferrous sulfate, stannous sulfate, magnesium sulfate, or combinations thereof. Embodiment 12 is the method of any of embodiments 1 to 11, wherein the spent hydrocarbon dehydrogenation catalyst is ground into a raw meal that has a particle size in a range of 1 μm to 200 μm. Embodiment 13 is the method of any of embodiments 1 to 12, wherein the sintering temperature is in a range of 1400 to 1500° C. Embodiment 14 is the method of any of embodiments 1 to 13, wherein the cement contains spent hydrocarbon dehydrogenation catalyst in the range of 0.02 to 0.2 wt. % of the total raw materials used for cement production.

Embodiment 15 is a composition including (a) a raw material containing chromium and alumina, wherein the raw material is produced via steps including grinding a spent hydrocarbon dehydrogenation catalyst containing chromium supported on alumina to produce a raw meal, heating the raw meal at a sintering temperature to produce a clinker, cooling the clinker to produce a cooled clinker, and grinding the cooled clinker to produce the processed raw material. The composition further includes (b) a reducing agent configured to reduce Cr⁶⁺ in the cement, (c) gypsum, and (d) bauxite.

All embodiments described above and herein can be combined in any manner unless expressly excluded.

Although embodiments of the present invention have been described with reference to blocks of the FIGURE, it should be appreciated that operation of the present invention is not limited to the particular blocks and/or the particular order of the blocks illustrated in the FIGURE. Accordingly, embodiments of the invention may provide functionality as described herein using various blocks in a sequence different than that of the FIGURE.

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of producing cement, the method comprising:
processing a spent hydrocarbon dehydrogenation catalyst comprising alumina to produce a processed raw material; and
using the processed raw material as a component for producing the cement.

2. The method of claim 1, wherein the spent hydrocarbon dehydrogenation catalyst comprises chromium supported on alumina.

3. The method of claim 2, wherein the chromium of the spent hydrocarbon dehydrogenation catalyst is in a form of Cr₂O₃, CrO₃, K₂CrO₄, Cr₂O₃Al₂O₃, or combinations thereof.

4. The method of claim 2, wherein the cement comprises less than 0.02 ppmw Cr⁶⁺ from the spent catalyst.

5. The method of claim 1, wherein the spent hydrocarbon dehydrogenation catalyst has a particle size in a range of 2 microns to 3 mm.

6. The method of claim 1, wherein the catalyst comprises 10 to 16 wt. % chromium and 75 to 85 wt. % alumina.

7. The method of claim 1, wherein the alumina is in a form of gamma-alumina, theta-alumina, and delta-alumina, chromia-alumina mixed oxide, or combinations thereof.

8. The method of claim 1, wherein the processed raw material is used as an alumina source for the cement.

9. The method of claim 1, wherein the processing step comprises: grinding a spent hydrocarbon dehydrogenation catalyst comprising chromium supported on alumina to produce a raw meal;
heating the raw meal at a sintering temperature to produce a clinker;
cooling the clinker to produce a cooled clinker; and
grinding the cooled clinker to produce the processed raw material.

10. The method of claim 9, wherein the cement is produced via a step comprising:
mixing the processed raw material with gypsum and a reducing agent to produce a cement.

11. The method of claim 10, wherein the reducing agent comprises ferrous sulfate, stannous sulfate, magnesium sulfate, or combinations thereof.

12. The method of claim 9, wherein the spent hydrocarbon dehydrogenation catalyst is ground into a raw meal that has a particle size in a range of 1 micron to 200 μm.

13. The method of claim 9, wherein the sintering temperature is in a range of 1400 to 1500° C.

14. The method of claim 9, wherein the cement comprises spent hydrocarbon dehydrogenation catalyst in the range of 0.02 to 0.2 wt. % of total raw materials used for cement production.

15. A composition comprising:
(a) a raw material comprising chromium and alumina, wherein the raw material is produced via steps comprising:
grinding a spent hydrocarbon dehydrogenation catalyst comprising chromium supported on alumina to produce a raw meal;
heating the raw meal at a sintering temperature to produce a clinker;
cooling the clinker to produce a cooled clinker; and
grinding the cooled clinker to produce the processed raw material;
(b) a reducing agent configured to reduce Cr⁶⁺ in the cement;
(c) gypsum; and
(d) bauxite.
